(19) United States
(12) Patent Application Publication
(10) Pub. No.: US 2025/0130453 A1
(43) Pub. Date: Apr. 24, 2025

(54) MULTI-FUNCTIONAL DISPLAY AND DISPLAY SCREEN SYSTEM

(71) Applicant: Suzhou Pinyu Precision Mechanical Co., Ltd., Suzhou (CN)

(72) Inventor: Ruxun DONG, Zhuhai City (CN)

(21) Appl. No.: 18/919,307

(22) Filed: Oct. 17, 2024

(30) Foreign Application Priority Data
Oct. 20, 2023 (CN) 202311360606.1
Sep. 27, 2024 (CN) 2024223633741
Sep. 27, 2024 (CN) 2024223633794

(51) Int. Cl. G02F 1/1333; G02F 1/1345

(52) U.S. Cl. CPC G02F 1/133308; G02F 1/13452

(57) ABSTRACT

Provided is a multi-functional display, comprising a support, the support includes a longitudinal rod; and a rectangular display screen, the display screen is provided with a first length side and a second length side opposite to each other, and a first width side and a second width side opposite to each other; and the display screen is arranged to rotate relative to the longitudinal rod around an axis perpendicular to the display screen, and a distance between the axis and the first length side is smaller than a distance between the axis and the second length side. The multi-functional display is provided with at least a first working state and a second working state; in the first working state, the first length side and the second length side are both parallel to a horizontal axis, and the first length side is located below the second length side.

### TECHNICAL FIELD

The present disclosure relates to the field of computer equipment, and in particular to a multi-functional display screen and a display screen system.

### BACKGROUND

The description of this section merely provides background information related to the present disclosure and does not constitute prior art.

In the prior art, it is occasionally necessary to rotate the display screen of a computer (such as a desktop or laptop computer) to enable the display screen to serve different application scenarios. For instance, when the length side of the display screen is in a horizontal position, it is generally more conducive to routine operations, movie watching, etc. by the operator. Conversely, when the length side of the display screen is set vertically, it is typically more beneficial for tasks such as coding, drawing, text reading, and project management operations, which require the screen to be placed vertically.

Obviously, if it can be applied to more scenarios, it will be more convenient for operators to make choices based on actual situations.

It should be noted that the introduction to the background above is solely for the purpose of facilitating a clear and complete description of the technical solution of the present disclosure and enhancing its understanding by a person skilled in the art. The mere mention of these solutions in the background section of the present disclosure should not be construed as indicating that they are commonly known to a person skilled in the art.

### SUMMARY

Based on the aforementioned deficiencies in the prior art, the present disclosure introduces a multi-functional display with a wider range of application scenario options.

In order to achieve the above objects, the present disclosure provides the following technical solutions: The embodiment of the present disclosure discloses a multi-functional display, comprising:
a support, wherein the support includes a longitudinal rod; and
a rectangular display screen, wherein the display screen is provided with a first length side and a second length side opposite to each other, and a first width side and a second width side opposite to each other; and the display screen is arranged to rotate relative to the longitudinal rod around an axis perpendicular to the display screen, and a distance between the axis and the first length side is smaller than a distance between the axis and the second length side.

### BRIEF DESCRIPTION OF THE DRAWINGS

The accompanying drawings described herein are for explanatory purposes only and are not intended to limit the scope of the present disclosure in any way. Additionally, the shapes and proportional dimensions of the various components in the figures are merely illustrative and are used to facilitate understanding of the present disclosure, rather than specifically defining the shapes and proportional dimensions of each component of the present disclosure. A person skilled in the art, guided by the teachings of the present disclosure, may choose various possible shapes and proportional dimensions to implement the present disclosure based on specific circumstances. In the accompanying drawings:

FIG. 1 is a schematic structural diagram of a multi-functional display screen according to an embodiment of the present disclosure.

FIG. 2 is a schematic structural diagram of a multi-functional display screen in a first working state according to an embodiment of the present disclosure.

FIG. 3 is a schematic structural diagram of a multi-functional display screen in a second working state according to an embodiment of the present disclosure.

FIG. 4 is a schematic structural diagram of a multi-functional display screen in a third working state according to an embodiment of the present disclosure.

FIG. 5 is a schematic structural diagram of a multi-functional display screen in a fourth working state according to an embodiment of the present disclosure.

FIG. 6 is a schematic structural diagram of a multi-functional display screen in a fifth working state according to an embodiment of the present disclosure.

FIG. 7 is a schematic structural diagram of attaching a second connecting unit to a display screen after the base is removed according to an embodiment of the present disclosure.

FIG. 8 is a cross-sectional view of a rotary positioning mechanism for a display.

FIG. 9 is a schematic cross-sectional view of a rotary positioning mechanism.

FIG. 10 is a schematic diagram of removing a cover body by the rotary positioning mechanism.

FIG. 11 is a cross-sectional view along direction A-A in FIG. 1.

FIG. 12 is a schematic structural diagram of a display unit and a supporting unit in a disengaged state in a display system along direction A-A in FIG. 1.

FIG. 13 is a schematic structural diagram of a base attached to a display screen after being removed from a display screen.

FIG. 14 is a schematic cross-sectional view of FIG. 2.

FIG. 15 is a schematic structural diagram of a display screen.

FIG. 16 is a schematic structural diagram of a base.

FIG. 17 is a schematic structural diagram of a display screen system.

FIG. 18 is another schematic structural diagram of a display screen system.

FIG. 19 is a schematic structural diagram of a second connecting unit can rotate relative to the display screen after the base is removed in the embodiments of the present disclosure.

FIG. 20 is a schematic diagram of the position of a LCD control board according to the present disclosure.

FIG. 21 is a schematic diagram of a flexible connecting line according to the present disclosure.

FIG. 22 is a schematic diagram of the position of a screen control board according to the present disclosure.

FIG. 23 is a schematic diagram of the position of a screen control board according to another embodiment of the present disclosure.

FIG. 24 is a schematic structural diagram of the inner portion of a connecting body according to the present disclosure.

FIG. 25 is a schematic diagram of outward support of a second connecting unit according to the present disclosure.

FIG. 26 is a schematic diagram of a connecting back face and a supporting back face according to the present disclosure.

FIG. 27 is a schematic structural diagram of a pivoting mechanism according to the present disclosure.

FIG. 28 is a cross-sectional view of a pivoting mechanism according to the present disclosure.

FIG. 29 is a schematic structural diagram of a rotating shaft in a pivoting mechanism according to the present disclosure.

FIG. 30 is a schematic structural diagram of a rotating shaft in a pivoting mechanism according to the present disclosure.

FIG. 31 is an exploded view of a pivoting mechanism according to the present disclosure.

FIG. 32 is an exploded view of a pivoting mechanism according to the present disclosure.

FIG. 33 is a schematic diagram of a pivoting mechanism according to the present disclosure.

FIG. 34 is a partial enlarged view of FIG. 33 in the present disclosure.

FIG. 35 is a schematic diagram of a cam and a first pivoting extension unit according to the present disclosure.

FIG. 36 is a schematic structural diagram of a cam according to the present disclosure.

The reference numerals of the accompanying drawings are as follows: 1, support; 11, longitudinal rod; 12, base; 121, groove; 122, stop block; 2, display screen; 21, first length side; 22, second length side; 23, first width side; 24, second width side; 3, axis; 4, another display; 5, connecting portion; 51, first connecting unit; 511, cover plate; 512, mounting plate; 513, accommodating cavity; 514, rotating hub; 5141, positioning grooves; 515, display screen shell; 516, positioning unit; 5161, fastening unit; 51611, flange portion; 51612, threaded portion; 51613, mounting groove; 5162, elastic element; 5163, ball; 5171, first limiting portion; 5172, second limiting portion; 5181, first inner hole; 5182, second inner hole; 5183, third inner hole; 52, second connecting unit; 61, inserting mechanism; 62, magnetic attraction mechanism; 621, first magnetic attraction unit; 622, second magnetic attraction unit; 63, recessed portion; 64, protruding portion; 65, first electrical interface; 66, electric connecting portion; 71, third magnetic attraction unit; 72, fourth magnetic attraction unit; 81, LCD control board; 82, flexible connecting line; 83, screen control board; 531, connecting body; 532, connecting cover body; 5221, connecting back face; 533, connecting cavity; 31, supporting back face; 32, supporting front face; 9, pivoting mechanism; 91, first pivoting portion; 911, first pivoting fixing portion; 912, first pivoting extension unit; 92, second pivoting portion; 921, second pivoting fixing portion; 922, second pivoting extension unit; 93, rotating mechanism; 931, rotating groove; 932, rotating shaft; 933, rotating center; 934, bolt; 935, cam; 9351, protrusion; 9352, groove; 936, spring gasket; and 937, nut.

### DETAILED DESCRIPTION OF THE EMBODIMENTS

In order to enable those skilled in the art to better understand the technical solutions in the present disclosure, the technical solutions in the embodiments of the present disclosure will be clearly and completely described below with reference to the accompanying drawings in the embodiments of the present disclosure. Obviously, the described embodiments are only a part of the embodiments of the present disclosure, rather than all of the embodiments. Based on the embodiments of the present disclosure, all other embodiments obtained by those of ordinary skill in the art without creative efforts fall within the scope of protection of the present disclosure.

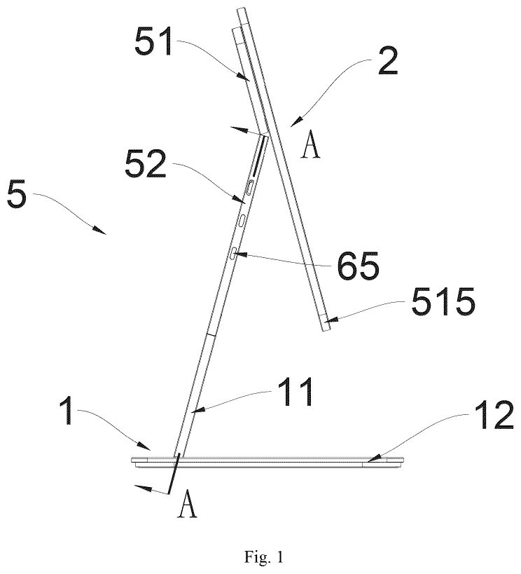

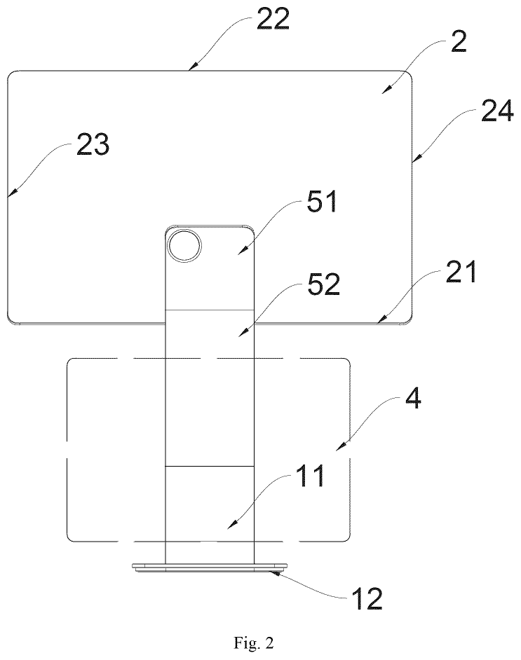

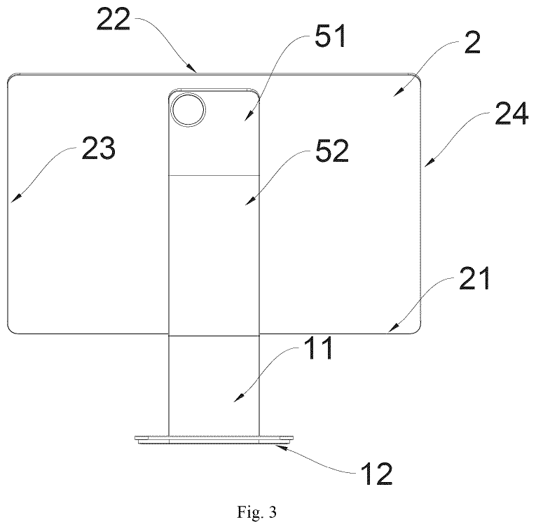

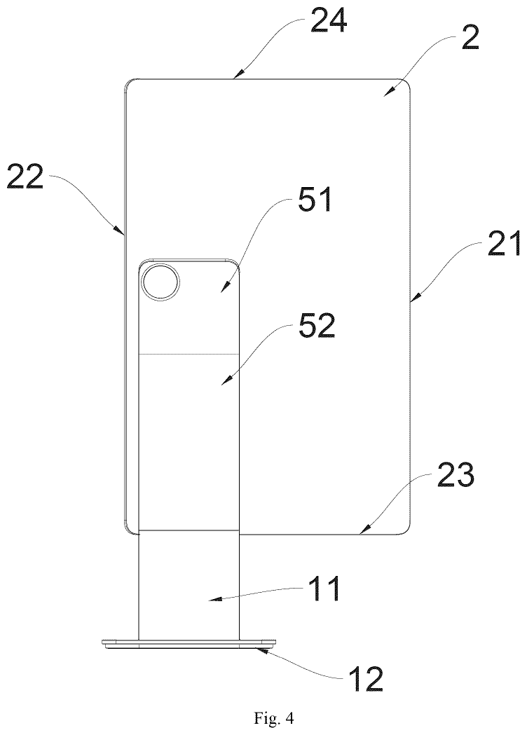

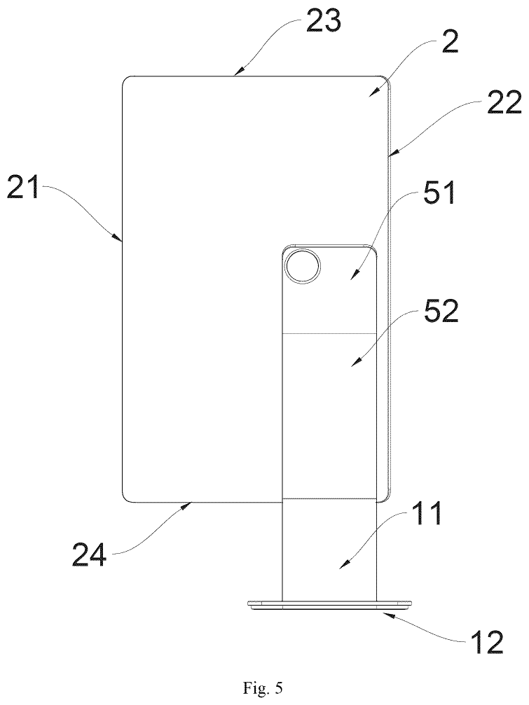

As shown in FIG. 1, FIG. 2, FIG. 3, FIG. 4 and FIG. 5, the embodiment of the present disclosure discloses a multi-functional display, comprising:
a support 1, wherein the support 1 includes a longitudinal rod 11; and
a rectangular display screen 2, wherein the display screen 2 is provided with a first length side 21 and a second length side 22 opposite to each other, and a first width side 23 and a second width side 24 opposite to each other; and the display screen 2 is arranged to rotate relative to the longitudinal rod 11 around an axis 3 perpendicular to the display screen 2, and a distance between the axis 3 and the first length side 21 is smaller than a distance between the axis 3 and the second length side 22.

Primarily referring to FIGS. 2 and 3, based on the aforementioned structure, the multi-functional display is provided with at least a first working state and a second working state; in the first working state, the first length side 21 and the second length side 22 are both parallel to a horizontal axis, and the first length side 21 is located below the second length side 22. In the first working state, a height capable of accommodating another display 4 is arranged between the first length side 21 and a bottom end face of the support 1. Another display 4 can be the screen of a laptop, a computer monitor, or another multi-function display of the same type. For example, in the first working state, the distance between the first length side 21 and the desktop can be 20 cm or more. In the first working state, the multi-function display and the another display 4 can be positioned vertically, facilitating easy observation by the operator.

In the second working state, the first length side 21 and the second length side 22 are both parallel to the horizontal axis, and the second length side 22 is located below the first length side 21. In the second working state, a height that facilitates better observation by an operator is arranged between the first length side 21 and the bottom end face of the support 1. For example, in the second working state, the distance between the first length side 21 and the desktop can be approximately 6-10 cm.

In summary, the present disclosure can be applied to more scenarios, making it more convenient for operators to make choices based on actual situations.

Primarily referring to FIGS. 4 and 5, a distance between the rotation axis 3 of the display screen 2 and the first width side 23 is the same as that of the second width side 24. The display screen 2 is provided with a third working state and a fourth working state. In the third working state, the first width side 23 and the second width side 24 are both parallel to the horizontal axis, and the first width side 23 is located below the second width side 24. In the fourth working state, the second width side 24 and the first width side 23 are both parallel to the horizontal axis, and the second width side 24 is located below the first width side 23. The third and fourth working states are basically similar, except that the display screen 2 is tilted to the left in one state and to the right in the other. Preferably, when the display screen 2 is in the third and fourth working states, the base 12 can also be removed, and it can still form a supporting state for the display screen 2.

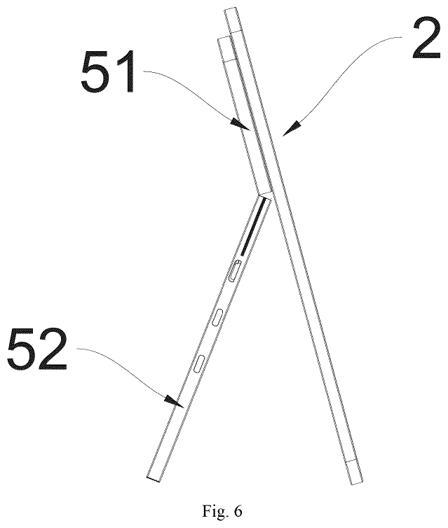

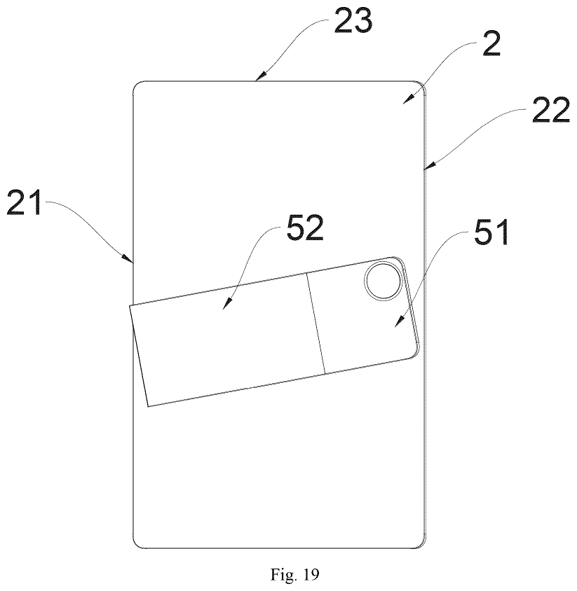

A connecting portion 5 is further arranged between the longitudinal rod 11 and the display screen 2, the connecting portion 5 includes a first connecting unit 51 and a second connecting unit 52 pivotally connected with the first connecting unit 51, and the first connecting unit 51 is rotationally connected with the display screen 2. The second connecting unit 52 is connected with the longitudinal rod 11 in an inserted mode, so that the display screen 2 is arranged to be connected with or separated from the base 12. As shown in FIG. 6, preferably, when the multi-functional display screen 2 is in a fifth working state and is separated from the base 12, the second connecting unit 52 and a bottom of the display screen 2 are arranged to form a supporting state for the display screen 2. Preferably, as shown in FIG. 7, the second connecting unit 52 can rotate relative to the first connecting unit 51, so that the second connecting unit 52 can be attached to the display screen 2 for easy portability. Preferably, as shown in FIG. 19, the first connecting unit 51 can rotate relative to the display screen 2 to allow the second connecting unit 52 to be placed in an optimal position, for example, by rotating to 0°, 90°, −90°, or other corresponding angles. More preferably, a magnetic component can be arranged between the second connecting unit 52 and the display screen 2. Thus, the second connecting unit 52 can be magnetically attached to the corresponding position on the display screen 2 as needed, for example, at 0°, 90°, −90°, or other corresponding angles.

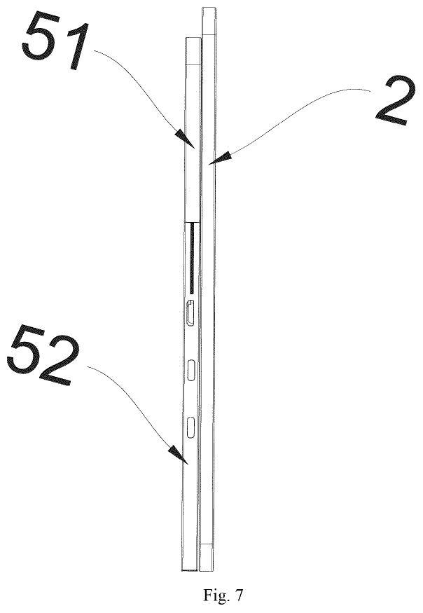

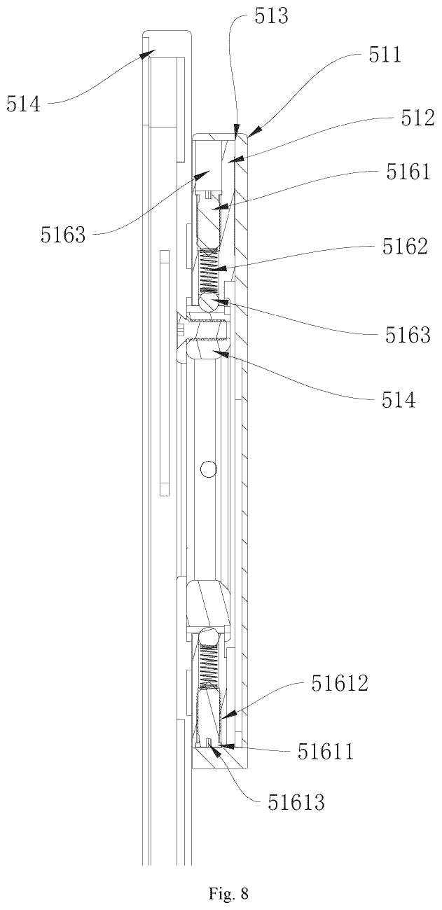

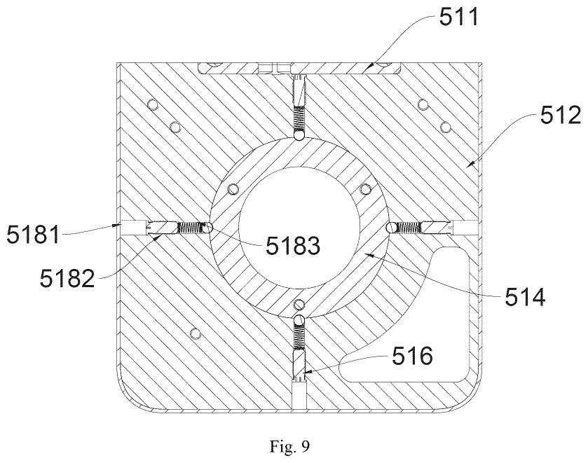

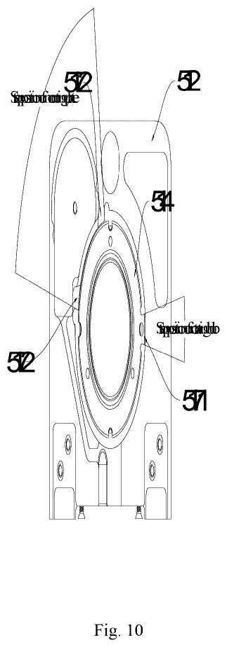

Referring to FIG. 8, FIG. 9 and FIG. 10, the first connecting unit 51 includes a cover body and a mounting plate 512, and the cover body is used for forming an accommodating cavity 513; and the mounting plate 512 is arranged in the accommodating cavity 513 of the cover body. A rotary positioning mechanism is further arranged between the first connecting unit 51 and the display screen 2. The rotary positioning mechanism includes:
a rotating hub 514, wherein the rotating hub 514 is arranged in the mounting plate 512 in a penetrating mode, the rotating hub 514 can rotate relative to the mounting plate 512, and a plurality of positioning grooves 5141 distributed in the circumferential direction are formed in the periphery of the rotating hub 514;
a display screen shell 515, wherein the display screen shell 515 is arranged on one side, away from the cover body, of the mounting plate 512, the display screen shell 515 is fixedly connected with the rotating hub 514, and the display screen 2 is arranged in the display screen shell 515; and
at least one positioning unit 516, each positioning unit 516 includes a fastening unit 5161 arranged on the mounting plate 512, an elastic element 5162 capable of extending and retracting in the radial direction, and a ball 5163, one end of the elastic element 5162 is fixedly arranged on the fastening unit 5161, another end of the elastic element 5162 abuts against the ball 5163, and in the rotating process of the rotating hub 514 relative to the mounting plate 512, the ball 5163 can be clamped into one of the plurality of positioning grooves 5141.

Based on the aforementioned structure, when the rotating hub 514, which is provided with the display screen shell 515, rotates to the point where the ball 5163 fits into one of the plurality of positioning grooves 5141, the positioning unit 516 allows the mounting plate 512 (i.e., the display screen shell 515) to be stably positioned on the mounting plate 512 in its current orientation. When it is necessary to rotate the display screen shell 515, a rotational force is applied to it, causing friction between the outer circumference of the rotating hub 514 and the ball 5163. As the display screen shell 515 rotates to a certain extent and the ball 5163 passes over one of the plurality of positioning grooves 5141, the outer circumference of the rotating hub 514 can abut against the ball 5163, exerting an outward force on the ball 5163 and compressing the elastic element 5162 (radially outward) until the mounting plate 512 rotates to the point where the ball 5163 fits into the next positioning groove 5141, achieving the next positioning state. Upon reaching the next positioning state, a clear mechanical sound is produced when the ball 5163 collides with the rotating hub 514, providing an indication to the operator.

In the embodiment, the cover body includes a cover plate 511 and a peripheral wall extending forwards from the cover plate 511, the cover plate 511 and the peripheral wall jointly form an accommodating cavity 513. Specifically, the support 1 of the display can further include a base 12, and the base 12 can be connected with the cover body so as to provide support for the display.

The mounting plate 512 is fixedly arranged in the accommodating cavity 513 of the cover body. For example, the mounting plate 512 can be connected with the mounting plate 512 through a fastener arranged on the peripheral wall of the cover plate 511 in a penetrating mode. In the embodiment, for the sake of strength and ease of processing, both the outer peripheries of the mounting plate 512 and the cover plate 511 can be rectangular. Of course, the outer peripheries of the mounting plate 512 and the cover plate 511 can also be adjusted as needed. A rotating hole for allowing the rotating hub 514 to penetrate through is formed in the mounting plate 512. The side wall of the mounting plate 512 is provided with a through hole for accommodating the positioning unit 516. The through hole is in communication with the rotating hole.

The rotating hub 514 is arranged in the mounting plate 512 in a penetrating mode, and the rotating hub 514 can rotate relative to the mounting plate 512. A plurality of positioning grooves 5141 distributed in the circumferential direction are formed in the periphery of the rotating hub 514. Preferably, each positioning groove 5141 extends along the axis 3 direction of the rotating hub 514. Furthermore, one of the plurality of the positioning grooves 5141 is arc-shaped in a cross-sectional direction perpendicular to the axis 3 of the rotating shaft. Obviously, one of the plurality of the positioning grooves 5141 is configured to be capable of accommodating the ball 5163, and when the rotating hub 514 is further rotated, one of the plurality of the positioning grooves 5141 does not cause the ball 5163 to be stuck, but the ball 5163 generates a force acting in the radial direction.

The display screen shell 515 is arranged on one side, away from the cover body, of the mounting plate 512, and the display screen shell 515 is fixedly connected with the rotating hub 514. In the power-on state, the display screen 2 in the display screen shell 515 can output text, pictures, patterns and other contents outwards.

Each positioning unit 516 includes a fastening unit 5161 arranged on the mounting plate 512, an elastic element 5162 capable of extending and retracting in the radial direction, and a ball 5163, one end of the elastic element 5162 is fixedly arranged on the fastening unit 5161, another end of the elastic element 5162 abuts against the ball 5163, and in the rotating process of the rotating hub 514 relative to the mounting plate 512, the ball 5163 can be clamped into one of the plurality of positioning grooves 5141.

Preferably, taking into account factors such as the pressure-bearing strength of the ball 5163, the ball 5163 can be a steel ball. The steel ball is fixedly connected to the other end of the elastic element 5162.

In the embodiment, the number of the positioning grooves 5141 and the number of the positioning units 516 are four, and the four positioning grooves 5141 and the four positioning units 516 are uniformly distributed along the circumference. Of course, the number and arrangement of the positioning grooves 5141 and the positioning units 516 can be set as required.

In the embodiment, at least one first limiting portion 5171 extending outwards in the radial direction is arranged on the periphery of the rotating hub 514, at least one second limiting portion 5172 extending inwards in the radial direction is arranged on the inner periphery of the mounting plate 512, and the first limiting portion 5171 can abut against the second limiting portion 5172, so that the rotating angle of the rotating hub 514 is limited. In the embodiment, by arranging the first limiting portion 5171 and the second limiting portion 5172, two stop positions at −90° and 180° are added, so that the display screen 2 can be adjusted between −90° and 180°, and can be positioned at −90°, 0°, 90°, and 180°, so that the inner wire material of the product is prevented from being damaged during rotation. Of course, in other optional embodiments, the rotation angle can also be set according to actual needs, for example, 30°, 45°, 60°, −30°, −45°, −60°, etc.

In a preferred embodiment, the mounting plate 512 is sequentially provided with a first inner hole 5181 and a second inner hole 5182 from outside to inside in the radial direction of the rotating hub 514, wherein each through hole includes the first inner hole 5181 and the second inner hole 5182, and the aperture of the first inner hole 5181 is larger than that of the second inner hole 5182. Each fastening unit 5161 penetrates through the through hole. The fastening unit 5161 includes a flange portion 51611 and a threaded portion 51612 connected to the flange portion 51611. A threaded unit matching the threaded portion 51612 is formed on the inner wall of the second inner hole 5182. The end face of the flange portion 51611 facing the threaded portion 51612 can abut against the outer end face of the second inner hole 5182. Based on the above structure, the fastening unit 5161 can be connected to the mounting plate 512 in a relatively simple manner.

A third inner hole 5183 penetrating through the second inner hole 5182 and the first inner hole 5181 is further formed in the inner side of the second inner hole 5182 of the mounting plate 512, the aperture of the third inner hole 5183 is smaller than that of the second inner hole 5182, and the outer end face of the third inner hole 5183 can abut against the end face of the threaded portion 51612 away from the flange portion 51611. No matter the third inner hole 5183 or the second inner hole 5182, the insertion position of the fastening unit 5161 can be limited, and the operation of mounting personnel can be facilitated. In particular, the flange portion 51611 is provided with a mounting groove 51613 on the side of the flange portion 51611 facing away from the threaded portion 51612. The mounting groove 51613 may be a shape such as a character, a cross, a rectangle, etc., which facilitates the operation of the operating tool.

In summary, the present disclosure possesses the following advantages: it can address the issue of the rotating structure lacking stop positions; it can protect the internal wiring harness of the screen; and the structure is simple, facilitating easy assembly.

An inserting mechanism 61 is arranged between the second connecting unit 52 and the longitudinal rod 11, and the inserting mechanism 61 is further provided with a magnetic attraction mechanism 62 arranged between the second connecting unit 52 and the longitudinal rod 11.

Based on the aforementioned structure, when connection is required, the second connecting unit 52 and the longitudinal rod 11, that is, the display screen 2 and the base 12, can be inserted through the inserting mechanism 61. Furthermore, they can achieve adsorption and stable connection under the action of the magnetic attraction mechanism 62. When disassembly is needed, after overcoming the magnetic attraction force, the second connecting unit 52 and the longitudinal rod 11 can be separated by moving in the direction opposite to the insertion, thereby enabling the separation of the display screen 2 and the base 12.

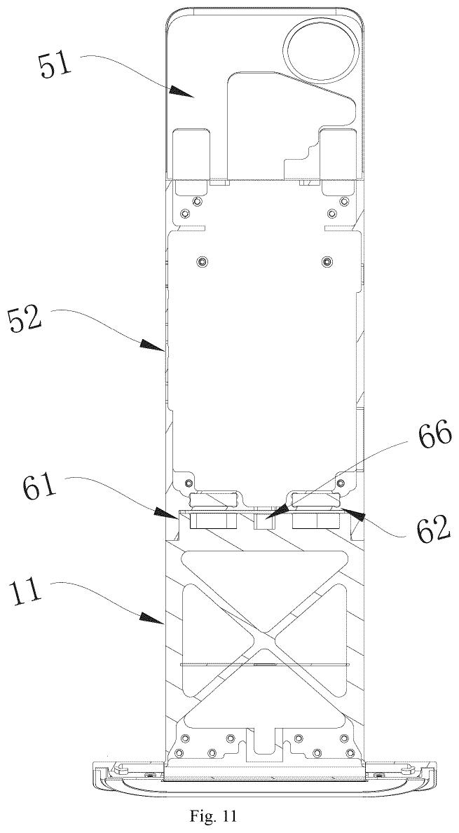

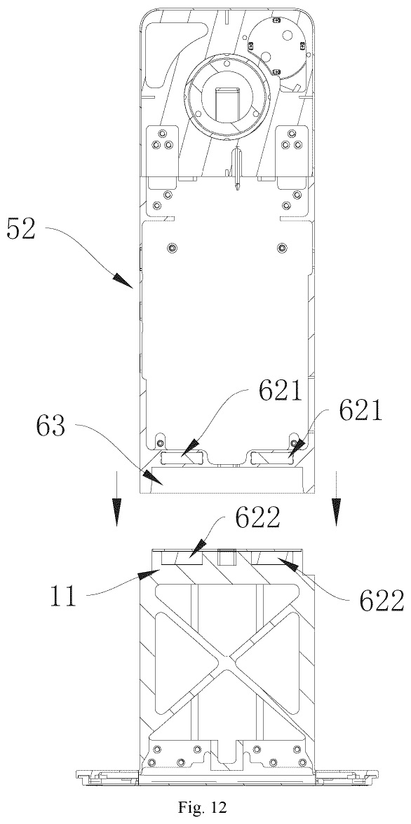

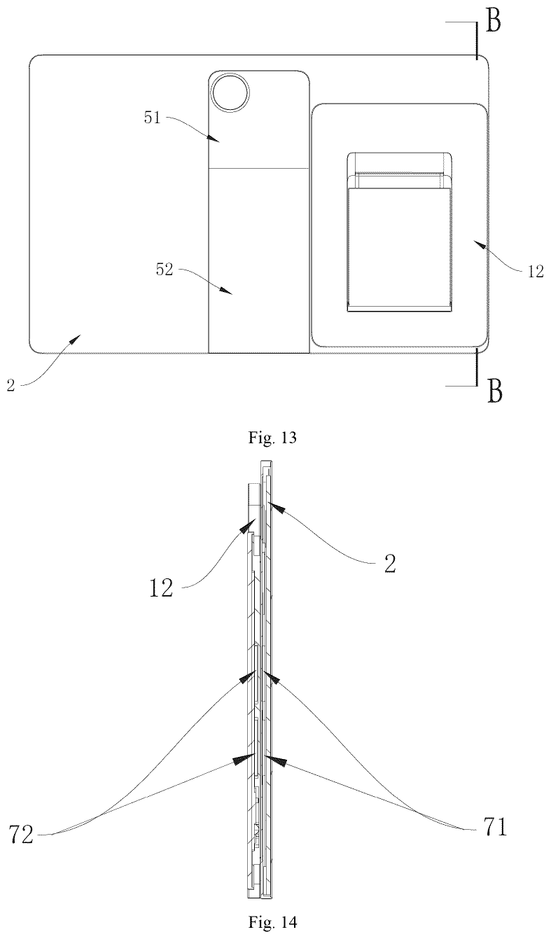

As shown in FIG. 11, FIG. 12 and FIG. 13, as mentioned above, the back face of the display screen 2 can be provided with a first connecting unit 51. The first connecting unit 51 is rotatably connected to the display screen 2, and the first connecting unit 51 is connected to the second connecting unit 52 via a pivot. Therefore, the second connecting unit 52 can be attached to the back face of the display screen 2 in a folded state. Additionally, the position, orientation, and angle of the display screen 2 can be adjusted via the second connecting unit 52 and the first connecting unit 51.

The support 1 includes a longitudinal rod 11 and a base 12, wherein the longitudinal rod 11 can rotate around an axis 3 relative to the base 12, so that when the second connecting unit 52 and the longitudinal rod 11 are in a connected state, the position, orientation and angle of the display screen 2 can be adjusted via the rotating shaft.

An inserting mechanism 61 can be arranged between the second connecting unit 52 and the longitudinal rod 11. Specifically, the free end of the second connecting unit 52 may be provided with a recessed portion 63 extending along the length direction of the second connecting unit 52, and the section of the recessed portion 63 is rectangular.

The longitudinal rod 11 includes a rod body and a protruding portion 64 protruding from the free end of the rod body, and the protruding portion 64 extends along the length direction of the longitudinal rod 11 and can be matched with the recessed portion 63. Preferably, the protruding portion 64 and the recessed portion 63 are arranged with a gap between them. The side wall of the protruding portion 64 is slightly smaller than the width of the recessed portion 63.

The magnetic attraction mechanism 62 includes a first magnetic attraction unit 621 formed on a first groove of the second connecting unit 52 and a second magnetic attraction unit 622 formed on a second groove of the longitudinal rod 11, wherein the first magnetic attraction unit 621 is arranged on the bottom wall forming the recessed portion 63 (extending in the direction perpendicular to the long axis of the second connecting unit 52), and the first magnetic attraction unit 621 extends in the direction perpendicular to the long axis of the second connecting unit 52. The second magnetic attraction unit 622 is arranged at the end of the rod body. The second magnetic attraction unit 622 extends in a direction perpendicular to the long axis of the longitudinal rod 11. When the bottom wall of the second connecting unit 52 abuts against the rod body of the longitudinal rod 11, the first magnetic attraction unit 621 and the second magnetic attraction unit 622 can also provide an adsorption force between the second connecting unit 52 and the longitudinal rod 11.

In another optional embodiment, the recessed portion 63 can also be arranged on a second rod body, and the corresponding protruding portion 64 can also be arranged on a first rod body.

In an optional embodiment, the side portion of the first rod body is provided with a first electrical interface 65 such as High-Definition Multimedia Interface (HDMI), Secure Digital Interface (SD), or Mini-HDMI, so that signals and/or power can be transmitted to the display screen 2.

In an optional embodiment, the base 12 is provided with a second electric interface, and the second electric interface can be electrically connected with the display screen 2 through the electric connecting portion 66, so that signals and/or power can be transmitted to the display screen 2. The electric connecting portion 66 may include a first insertion end protruding from a bottom wall of the recessed portion 63 and a second insertion end recessed inward from an end portion of the protruding portion 64 and matching the first insertion end. In the embodiment, the second electrical interface and the electric connecting portion 66 can both adopt a Type-C transmission mode. Preferably, the first insertion end is located in the recessed portion 63 and does not protrude from the recessed portion 63. In another optional embodiment, the electric connecting portion 66 may include a first insertion end recessed from a bottom wall of the recessed portion 63 and a second insertion end protruding outward from an end portion of the protruding portion 64 and matching the first insertion end. Based on the above structure, the electric connecting portion 66 not only can be used as an interface for electrical transmission, but also can play a guiding role in the insertion process of the second connecting unit 52 and the longitudinal rod 11.

Preferably, a groove 121 is formed in the side, facing the longitudinal rod 11, of the base 12, and the longitudinal rod 11 can be folded into the groove 121 of the base 12. In particular, a third magnetic attraction unit 71 is arranged on the base 12, a fourth magnetic attraction unit 72 is arranged on the back face of the display screen 2, and under the state that the base 12 is separated from the display screen 2, the base 12 can be attached to the back face of the display screen 2 through the third magnetic attraction unit 71 and the fourth magnetic attraction unit 72, thereby facilitating portability.

Based on the aforementioned technical solution, the beneficial effects of the present disclosure are as follows:
1. It facilitates easy assembly and disassembly of the base 12 and the display screen 2;
2. The display screen 2 system can be provided with a plurality of adjusting joints, enabling it to meet various position, angle, and posture requirements of different individuals;
3. The electric connecting portion 66 arranged between the display screen 2 and the base 12 not only can be used as an electrical transmission interface, but also can play a guiding role in the insertion process of the first vertical rod and the second vertical rod.

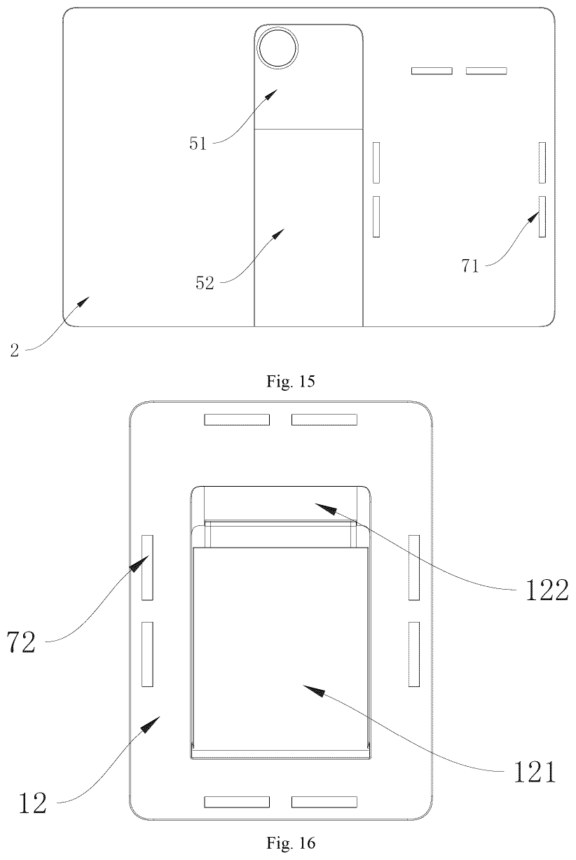

As shown in FIG. 14, FIG. 15 and FIG. 16, in a preferred embodiment, the base 12 is detachably arranged on the display screen 2. The display screen 2 is provided with a display face and a back face opposite to the display face, a third magnetic attraction unit 71 is arranged on the back face of the display screen 2, and a fourth magnetic attraction unit 72 that can magnetically attract the third magnetic attraction unit 71 is arranged on the bottom wall of the base 12.

Based on the aforementioned structure, after the base 12 is detached from the display screen 2, the base 12 can be attracted to the third magnetic attraction unit 71 of the display screen 2 through the fourth magnetic attraction unit 72, so that in the carrying process, the operator only needs to hold or grip the display screen 2 with one hand to complete carrying of the display. The display structure in the state of FIG. 14 is ultra-thin. For example, the thickness in this state does not exceed 13 mm.

Specifically, similar to the prior art, the display screen 2 can be in a plate shape. The display screen 2 is provided with a display surface and a front surface opposite to the display surface. The display screen 2 includes a display frame and a liquid crystal display (LCD) screen arranged in the display frame. In the power-on state, the display screen 2 can output text, pictures and other interfaces outwards through the front surface of the LCD screen. The third magnetic attraction unit 71 is arranged on the inner side of the back face of the display screen 2, that is, between the back face of the display screen 2 and the LCD screen, so that the back face of the display frame can be smooth and flat. Correspondingly, the fourth magnetic attraction unit 72 is arranged on the inner side wall of the bottom wall of the base 12 (i.e., located on the bottom wall in the base 12). Therefore, the bottom wall of the base 12 can be smooth and flat.

In order to enhance the adsorption force between the third magnetic attraction unit 71 and the fourth magnetic attraction unit 72, and to prevent accidental detachment of the base 12 and the display screen 2, a plurality of fourth magnetic attraction units 72 are arranged, and the plurality of fourth magnetic attraction units 72 are distributed around the bottom wall of the base 12.

In a preferred embodiment, the back surface of the display screen 2 is provided with a first supporting unit, and the first supporting unit includes a first connecting unit 51 rotatably connected to the display screen 2 and a second connecting unit 52 pivotally connected to the connecting portion 5. Therefore, the first supporting unit and the display screen 2 can be tightly attached via the second connecting unit 52, thereby further reducing the volume occupied by the display screen 2 during carrying.

In particular, the thickness of the base 12 is not greater than the thickness of the first supporting unit. In this way, when the back face of the base 12 and the back face of the display screen 2 are in an adsorption state and the first supporting unit is attached to the back face of the display screen 2, the base 12 does not protrude out of the first supporting unit.

The display further comprises a longitudinal rod 11 rotatably connected to the base 12, and the longitudinal rod 11 is detachably connected to the second connecting unit 52 via the inserting mechanism 61. For example, the free end of the longitudinal rod 11 is provided with a protruding portion, and the free end of the second connecting unit 52 is provided with an inserting groove matched with the protruding portion of the longitudinal rod 11. The top of the base 12 is provided with a groove 121 for folding the longitudinal rod 11 when the longitudinal rod 11 is detached from the first supporting unit. The groove 121 is internally provided with a stop block 122 which is used for limiting the protruding portion when the longitudinal rod 11 is in a folded state, thereby further reducing the thickness of the longitudinal rod 11 and the base 12 in the folded state, and ensuring that the combined thickness of the base 12 and the longitudinal rod 11 is not greater than the thickness of the first supporting unit.

In the embodiment, the bottom wall of the base 12 is rectangular. Of course, in other optional embodiments, the bottom wall of the base 12 may also be circular, oval, square or other regular or irregular shapes as needed.

The base 12 is provided with two opposite long sides and two opposite wide sides, four groups of fourth magnetic attraction units 72 are arranged, and the four groups of fourth magnetic attraction units 72 are arranged on the two long sides and the two wide sides respectively; three groups of third magnetic attraction units 71 are arranged, the two groups of third magnetic attraction units 71 are used for corresponding to the two groups of fourth magnetic attraction units 72 arranged on the long sides of the base 12, the other group of third magnetic attraction units 71 are located in the center of the display screen 2 in the width direction, and the other group of third magnetic attraction units 71 are used for being corresponding to one group of the two groups of fourth magnetic attraction units 72 arranged on the wide sides of the base 12. Each group of third magnetic attraction units 71 corresponds to a group of fourth magnetic attraction units 72, and the number in each group can be 1, 2, 3, or any other quantity.

Therefore, the third magnetic attraction units 71 are located on the side portion of the display screen 2, and when the base 12 is attached to the display screen 2, the base 12 is completely covered by the display screen 2. Meanwhile, the base 12 can be firmly adsorbed on the back surface of the display screen 2, and the orientation of the width side of the base 12 cannot be limited. Moreover, the number of the third magnetic attraction units 71, which is only three groups, serves two purposes: on the one hand, it reduces costs; on the other hand, it ensures that one width side of the base 12 can be limited to be located in the middle of the display screen 2, avoiding the situation that part of the base 12 is located on the outer side of the display screen 2, and thereby avoiding potential damage during the carrying process.

Based on the aforementioned technical solution, the beneficial effects of the present disclosure are as follows:
1. During the carrying process, the operator only needs to hold or grip the display screen 2 with one hand to complete the carrying of the display;
2. It ensures that both the base 12 and the display screen 2 are flat and smooth;
3. It has a small volume during carrying;
4. The adsorption force is large, while the orientation of the width side of the base 12 is not limited;
5. While reducing costs, it ensures that the base 12 is located within the range of the display screen 2 during carrying.

Referring to FIG. 2, the embodiment of the present disclosure further discloses a display screen 2 system, comprising a first display and a second display (indicated by the dashed lines in the figure), wherein the first display includes a support 1, the support 1 includes a longitudinal rod 11;
a rectangular display screen 2, wherein the display screen 2 is provided with a first length side 21 and a second length side 22 opposite to each other, and a first width side 23 and a second width side 24 opposite to each other; and the display screen 2 is arranged to rotate relative to the longitudinal rod 11 around an axis 3, and a distance between the axis 3 and the first length side 21 is not equal to a distance between the axis 3 and the second length side 22; and
wherein, the first display is provided with at least a first working state and a second working state; in the first working state, the first length side 21 and the second length side 22 are both parallel to a horizontal axis, and the first length side 21 is located below the second length side 22; in the first working state, a height capable of accommodating the second display is arranged between the first length side 21 and the support 1; and the second display is located below the first display. In the second working state, the first display is in the normal and conventional observation position for the operator. Preferably, in the first working state, the first display and the second display are positioned via a magnetic attraction structure.

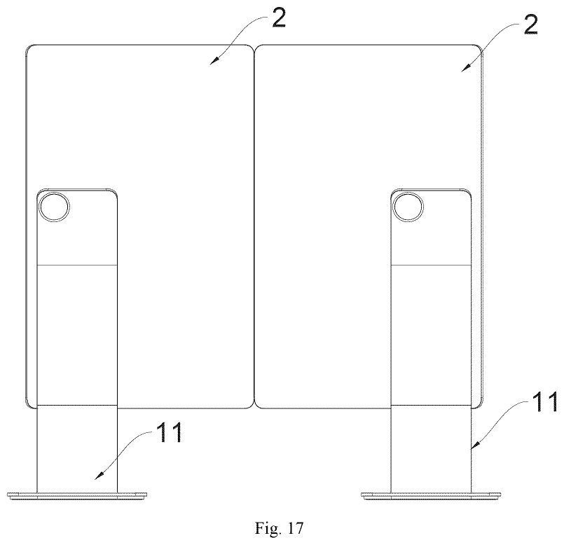

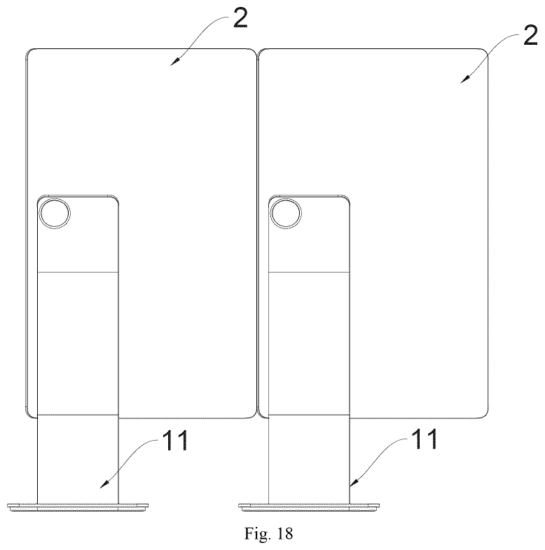

As shown in FIG. 17 and FIG. 18, the embodiment of the present disclosure further discloses a display screen 2 system, comprising a plurality of multi-functional displays arranged in parallel as aforementioned, wherein each of the plurality of multi-functional displays is in a third working state and/or a fourth working state; and
in the third working state, the first width side 23 and the second width side 24 are both parallel to the horizontal axis, and the first width side 23 is located below the second width side 24; and in the fourth working state, the second width side 24 and the first width side 23 are both parallel to the horizontal axis, and the second width side 24 is located below the first width side 23. The magnetic attraction structure is arranged between any two displays for positioning. In conclusion, each multi-functional display can be arranged in parallel as needed.

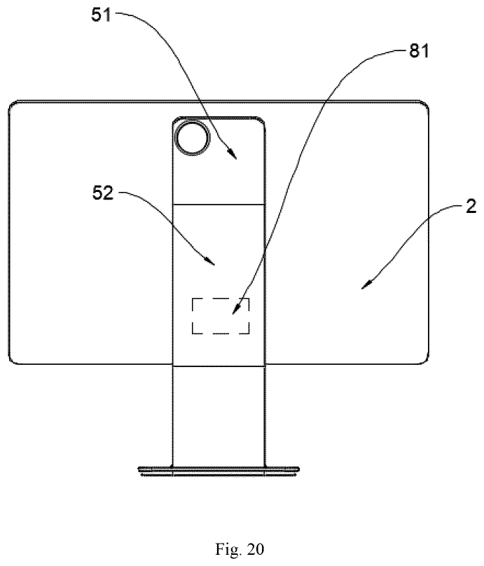

Referring to FIG. 20, the embodiment provides a multi-functional display, comprising a liquid crystal display (LCD) control board 81, the LCD control board 81 is accommodated in the second connecting unit 52. The LCD control board 81 can be electrically connected to the first electrical interface 65 and the second electrical interface.

Based on the aforementioned structure, unlike the LCD control board 81 in the prior art, which is generally integrated in the display screen 2, the LCD control board 81 in the embodiment of the present disclosure is arranged in the second connecting unit 52, thereby maintaining the thickness of the display screen 2 at a small value.

Specifically, for the purpose of achieving a small thickness, the display screen 2 can be in a flat plate shape. The display screen 2 can output text, pictures, videos and the like outwards in the power connection state. The display screen 2 has a thickness that extends in the thickness direction, and the thickness of the display screen 2 in the embodiment can be within 6 mm.

The connecting portion 5 can connect the display screen 2 and the second connecting unit 52, so that the second connecting unit 52 can support the display screen 2 and the connecting portion 5.

In the embodiment, the connecting portion 5 can rotate around an axis parallel to the thickness direction relative to the display screen 2. The second connecting unit 52 can rotate relative to the connecting portion 5 along the other axis perpendicular to the thickness direction.

Of course, in other optional embodiments, the connecting portion 5 can be respectively connected to the display screen 2 and the second connecting unit 52 by means of other connecting mechanisms.

In order to reduce the thickness of the display screen 2, some display screens 2 may be provided with an insertion structure on the side surface of the display screen 2. In this way, when the operator faces the display screen, the connecting wire is directly visible, consequently making the whole system appear disorganized due to this structure. Furthermore, limited by the connecting wire, the rotatable angle of the display screen 2 relative to the bracket is small.

Different from the prior art, in another optional embodiment, the second connecting unit 52 is provided with interfaces on both sides of its width, and the interfaces are electrically connected to the LCD control board. In the embodiment, the electric connecting wire is no longer connected with the display screen 2. As a result, the rotation of the display screen is not limited by the electric connecting wire. Therefore, in a preferred embodiment, the second connecting unit 52 can rotate around an axis perpendicular to the display screen 2 relative to the display screen 2 through the connecting portion 5. As shown in FIG. 21, to further eliminate restrictions on the rotation of the display screen 2, a flexible connecting line 82 is arranged between the second connecting unit 52 and the connecting portion 5, and the LCD control board 81 is electrically connected with the display screen 2 through the flexible connecting line 82. However, even with this arrangement, the connecting portion can rotate relative to the display screen within a preset range of angles, such as 0-270°. In general, the preset rotation angle of the connecting portion is less than 360°.

Specifically, the second connecting unit 52 can also be in a plate shape, so that the second connecting unit 52 and the display screen 2 can be jointly supported on the supporting surface, so that the multi-functional display is in a stable state.

Alternatively, the bottom of the second connecting unit 52 may also be provided with a support placed on the supporting surface, so that the support can provide support for the multi-functional display.

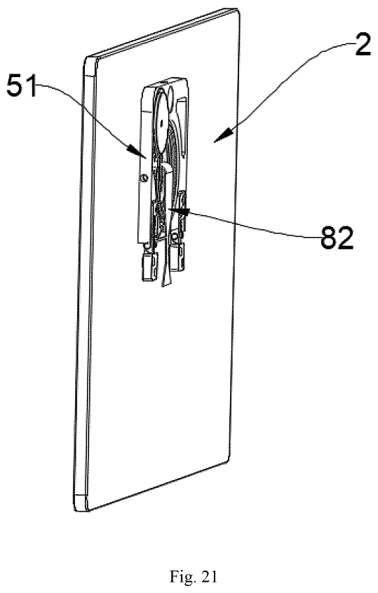

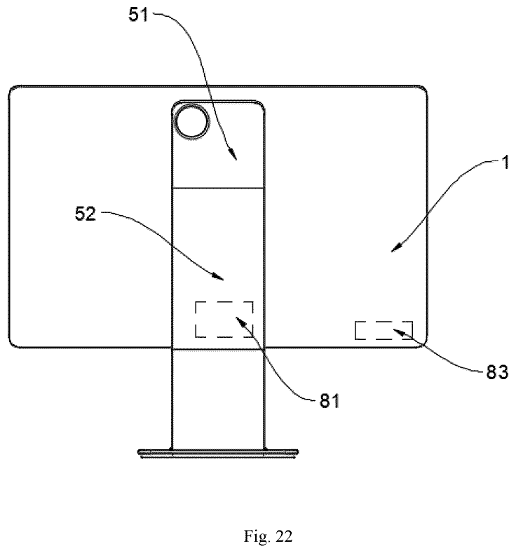

As shown in FIG. 22, in an optional embodiment, the multi-functional display further comprises a screen control board 83, and the screen control board 83 is arranged on the display screen 2. For example, the screen control board 83 can be placed in parallel with the LCD screen of the display screen 2, such that the thickness of the display screen 2 is maintained at a smaller value.

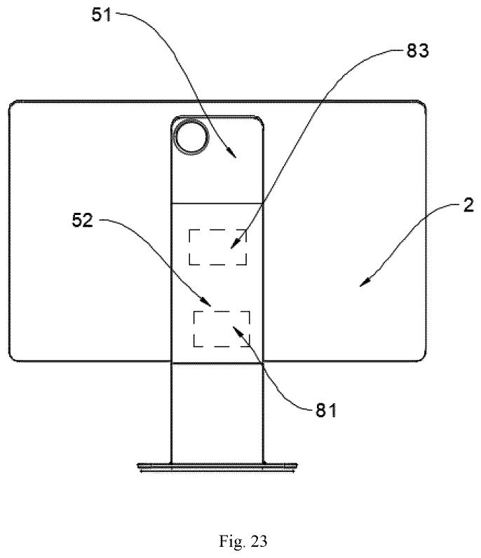

As shown in FIG. 23, in another optional embodiment, the multi-functional display further comprises a screen control board 83, and the screen control board 83 is arranged on the second connecting unit 52. In the embodiment, the screen control board 83 and the LCD control board 81 are both arranged on the second connecting unit 52, so that the thickness of the display screen 2 can be controlled to be smaller.

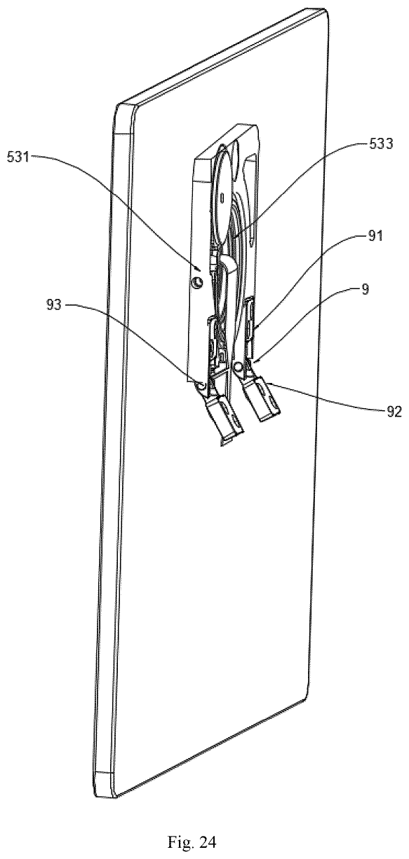

As shown in FIG. 24, the embodiment of the present disclosure provides a display screen device. The first connecting unit 51 includes a connecting body 531 arranged on a back face of a display screen 2 and a connecting cover body 532 arranged on a back face of the connecting body 531; and the second connecting unit 52 is provided with a supporting back face 31 that faces away from the display screen 2; the display screen device further comprises a pivoting mechanism 9, the pivoting mechanism 9 includes a first pivoting portion 91 arranged on the first connecting unit 51 and a second pivoting portion 92 arranged on the second connecting unit 52, a rotating mechanism 93 is arranged between the second pivoting portion 92 and the first pivoting portion 91, the rotating mechanism 93 includes an arc-shaped rotating groove 931 and a rotating shaft 932 limited in the rotating groove 931, and a rotating center 933 of the rotating groove 931 is located on an intersection line of the connecting back face 5221 of the connecting cover body 532 and the supporting back face 31.

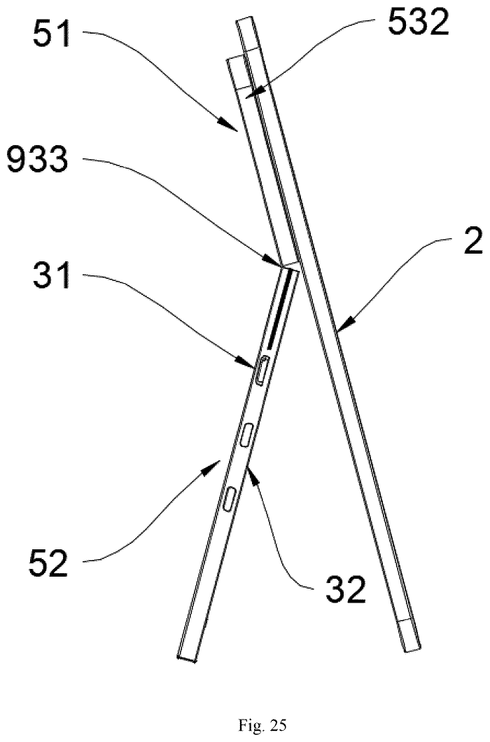

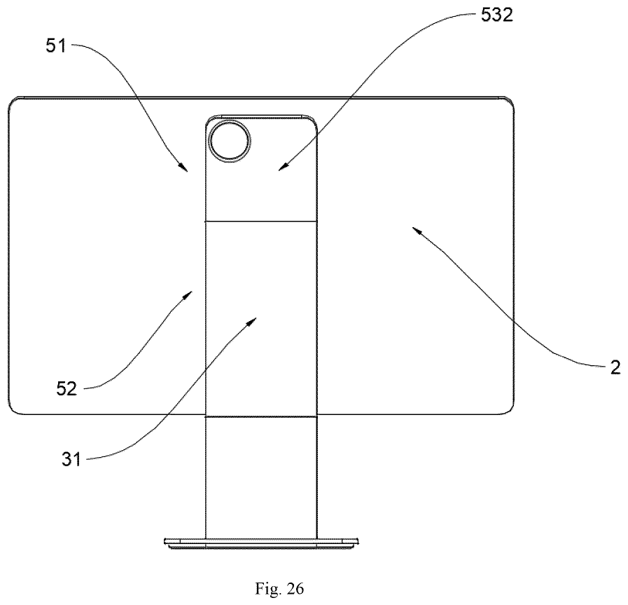

Based on the aforementioned structure, as shown in FIGS. 25 to 26, the structure not only enables the second connecting unit 52 to rotate relative to the connecting cover body 532, but also keeps the connecting back face 5221 of the connecting cover body 532 and the supporting back face 31 attached throughout the rotation process, allowing the connecting cover body 532 and the second connecting unit 52 to have relatively small thicknesses, thus making the display screen 2 device more aesthetically pleasing and structurally simpler.

Specifically, the display screen 2 can be in a flat plate shape and is used for outputting image-text information such as text, pictures, videos and the like outwards.

The first connecting unit 51 can include a connecting body 531 and a connecting cover body 532, wherein the connecting body 531 can be fixedly arranged on the back face of the display screen 2 through a fastener. Preferably, the connecting body 531 can rotate relative to the display screen 2 around the axis perpendicular to the display screen 2. The connecting cover body 532 can be fixed to the connecting body 531 through a fastening mechanism (such as a bolt, a screw and the like) arranged on the side face, so that the connecting cover body 532 can rotate along with rotation of the connecting body 531. When the connecting cover body 532 is arranged on the connecting body 531, the connecting cover body 532 is provided with a connecting back face 5221 away from the display screen 2, and when an operator or a consumer observes from the back face of the display screen 2, the connecting back face 5221 of the first connecting unit 51 can be seen.

Preferably, the connecting body 531 and the connecting cover body 532 form a connecting cavity 533 for the flexible connecting line to penetrate through.

The second connecting unit 52 is provided with a supporting front face 32 facing the display screen 2 and a supporting back face 31 facing away from the display screen 2, and when an operator or a consumer observes from the back face of the display screen 2, the supporting back face 31 of the second connecting unit 52 can be seen.

The first pivoting portion 91 can be fixedly arranged on the connecting body 531 of the first connecting unit 51 through a fastener. The second pivoting portion 92 can be fixedly arranged on the second connecting unit 52 through a fastener. Preferably, the second pivoting portion 92 can be arranged on the supporting front face 32 of the second connecting unit 52. As a result, installation can be facilitated and the fastener can be hidden.

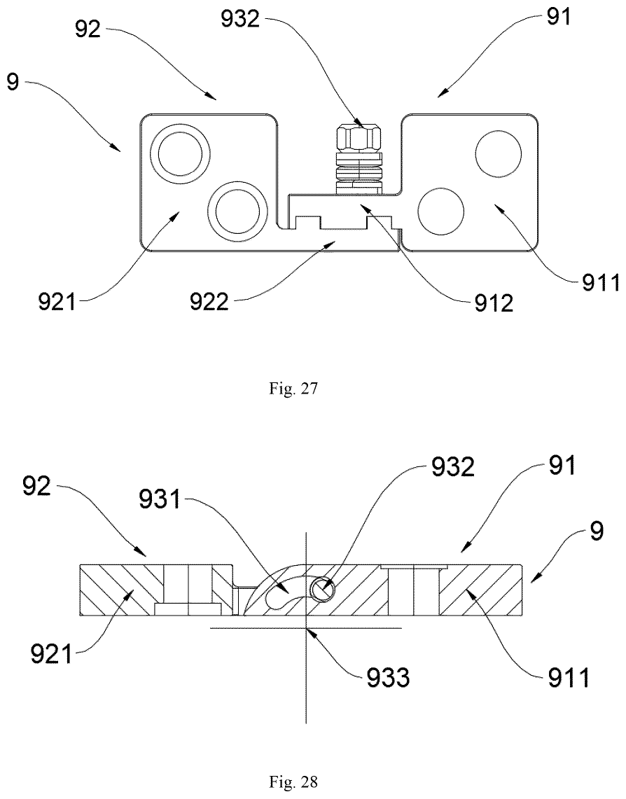

In the embodiment, as shown in FIG. 27 and FIG. 28, an arc-shaped rotating groove 931 is formed in the first pivoting portion 91. The rotating shaft 932 is arranged on the second pivoting portion 92. In the process that the second connecting unit 52 rotates along with the rotating portion, the rotating shaft 932 can move relatively in the rotating groove 931. As a result, the rotating center 933 of the rotating groove 931 is located on the intersection line connecting the connecting back face 5221 of the connecting cover body 532 and the supporting back face 31. Therefore, the rotating center 933 between the connecting back face 5221 and the supporting back face 31 coincides with the rotating center 933 of the rotating groove 931.

Of course, in another optional embodiment, the arc-shaped rotating groove 931 is arranged on the second pivoting portion 92. The rotating shaft 932 is arranged on the first pivoting portion 91.

In a preferred embodiment, the connecting back face 5221 of the connecting cover body 9 is attached to the supporting back face 31. In other words, the connecting back face 5221 can rotate around the intersection line where they meet. In this way, the design is simpler and more aesthetically pleasing.

In the embodiment, as shown in FIG. 25, FIG. 27 and FIG. 28, the first pivoting portion 41 includes a first pivoting fixing portion 911 arranged on the connecting body 531, and a first pivoting extension unit 912 integrally connected with the first pivoting fixing portion 911 and extending away from the display screen 2. The second pivoting portion 92 includes a second pivoting fixing portion 921 arranged on the second connecting unit 52, and a second pivoting extension unit 922 which is integrally connected with the second pivoting fixing portion 921 and extends towards the display screen 2. The rotating mechanism 93 is arranged between the first pivoting extension unit 912 and the second pivoting extension unit 922. Preferably, the display screen 2 device includes two first pivoting portions 91 and the second pivoting portion 92, which are symmetrically arranged along the center line. The rotating mechanism 93 can include two arc-shaped rotating grooves 931 symmetrically formed along the center line and the rotating shaft 932 penetrating through the two rotating grooves 931.

Particularly, when the supporting front face 32 of the second connecting unit 52 is attached to the display screen 2, the supporting back face 31 of the second connecting unit 52 is parallel to the connecting back face 5221.

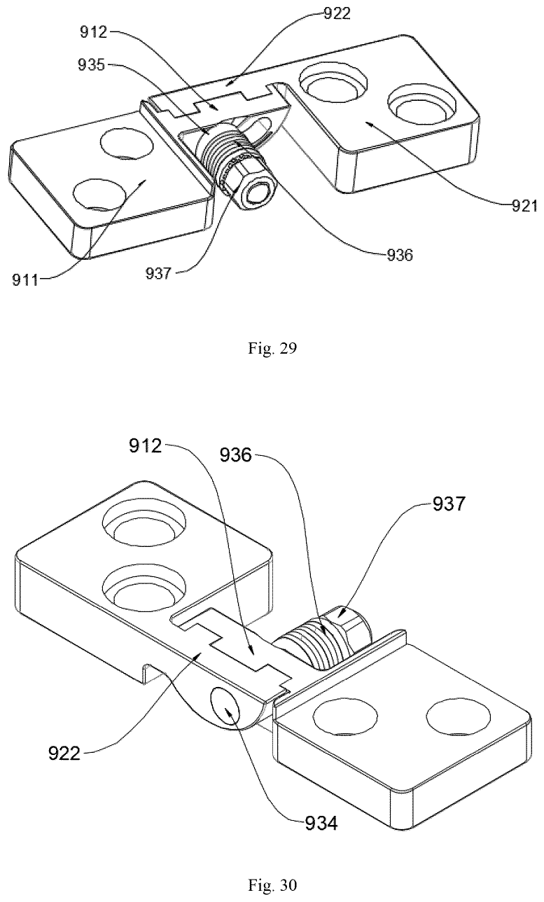

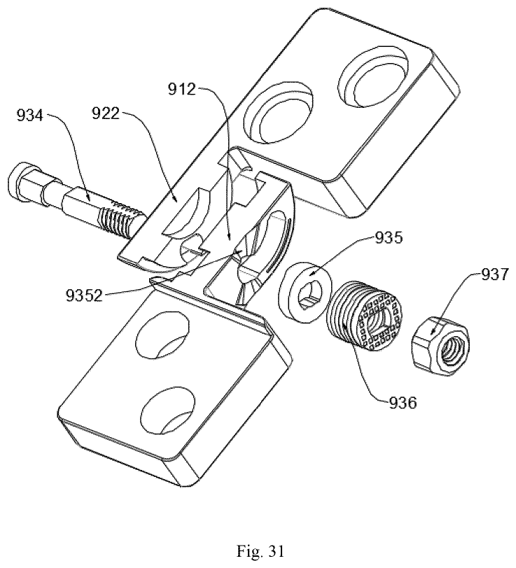

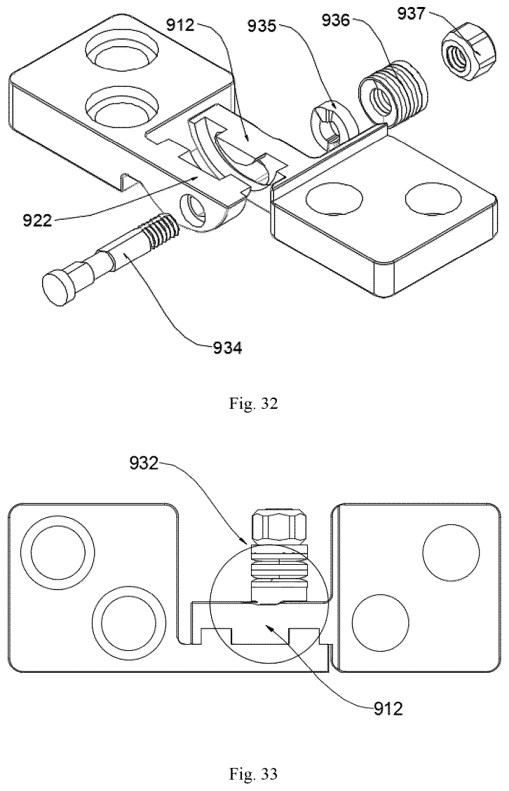

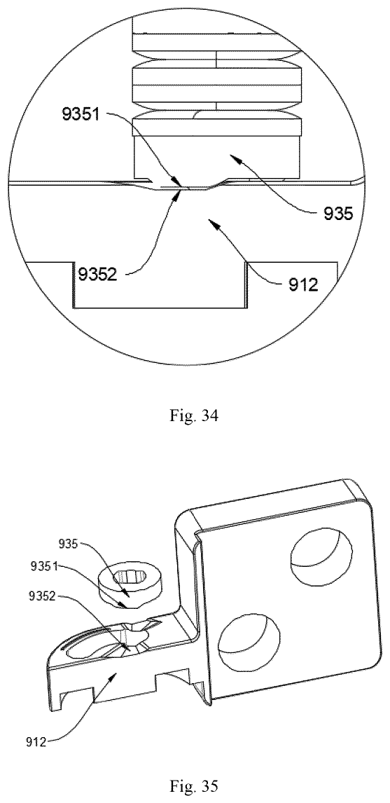

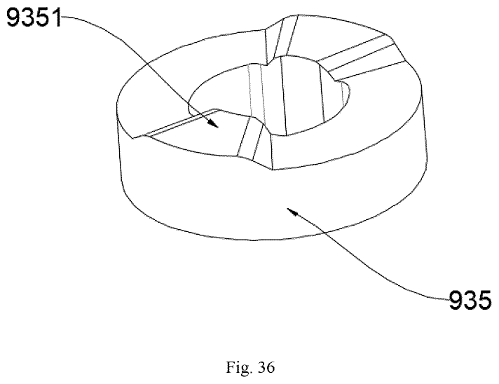

Furthermore, as shown in FIG. 29 to FIG. 36, the rotating shaft 932 includes a bolt 934 that sequentially passes through the second pivoting extension unit 922 and the first pivoting extension unit 912, and a cam 935, a spring gasket 936, and a nut 937 that are sleeved on the bolt 934 from inside to outside. The cam 935 is adjacent to the first pivoting extension unit 912, a protrusion 9351 is arranged on a side of the cam 935 facing the first pivoting extension unit 912. Correspondingly, the first pivoting extension unit 912 is provided with a matching groove 9352 for limiting the cam 935. Specifically, the magnitude of the force is adjusted by pre-tightening the nut 937, achieving a suitable tactile feel when adjusting the angle of the supporting portion. During rotation, the first pivoting extension unit 912 rotates relative to the cam 935, and the protrusion 9351 of the cam 935 moves out of the groove 9352 of the first pivoting extension unit 912 due to the rotation. At this point, the protrusion 9351 of the cam 935 abuts against the plane of the first pivoting extension unit 912. Simultaneously, the spring gasket 936 between the cam 935 and the nut 937 is compressed, and its elastic force reacts with the first pivoting extension unit 912. The friction force between the first pivoting extension unit 912 and the second pivoting extension unit 922 is increased by applying additional pressure, ensuring that the supporting portion 3 can provide stable support and fixation at any rotation angle. When the supporting front face 32 is completely attached to the back face of the display screen 1, the protrusion 9351 of the cam 935 is clamped into the groove 9352 of the first pivoting extension unit 912. At this point, the cam 935 and the nut 937 no longer exert pressure on the spring gasket 936, and the force is released, allowing the supporting front face 32 to remain fully attached to the back face of the display screen 1.

It should be understood that the above description is provided for illustrative purposes and is not intended to be limiting. Upon reading the aforementioned description, numerous embodiments and applications beyond the provided examples will become apparent to those skilled in the art. Therefore, the scope of the present teachings should not be determined with reference to the above description, but rather should be determined by the full scope of the preceding claims and their equivalents. For the purpose of completeness, all articles and references, including the disclosure of patent applications and publications, are incorporated herein by reference. The omission of any aspect of the subject matter disclosed here from the preceding claims is not intended to be a disclaimer of that subject matter, nor should it be construed as the applicant not considering such subject matter as part of the disclosed inventive subject matter.

What is claimed is:

1. A multi-functional display, comprising:
a support, wherein the support includes a longitudinal rod; and
a rectangular display screen, wherein the display screen is provided with a first length side and a second length side opposite to each other, and a first width side and a second width side opposite to each other; and the display screen is arranged to rotate relative to the longitudinal rod around an axis perpendicular to the display screen, and a distance between the axis and the first length side is smaller than a distance between the axis and the second length side.

2. The multi-functional display according to claim 1, wherein the multi-functional display is provided with at least a first working state and a second working state; in the first working state, the first length side and the second length side are both parallel to a horizontal axis, and the first length side is located below the second length side; and in the second working state, the first length side and the second length side are both parallel to the horizontal axis, and the second length side is located below the first length side.

3. The multi-functional display according to claim 1, wherein in the first working state, a height capable of accommodating another display is arranged between the first length side and a bottom end face of the support.

4. The multi-functional display according to claim 1, wherein in the second working state, a height that facilitates better observation by an operator is arranged between the first length side and the bottom end face of the support.

5. The multi-functional display according to claim 1, wherein a distance between the axis and the first width side is the same as that of the second width side; the display screen is provided with a third working state and a fourth working state; in the third working state, the first width side and the second width side are both parallel to the horizontal axis, and the first width side is located below the second width side; and in the fourth working state, the second width side and the first width side are both parallel to the horizontal axis, and the second width side is located below the first width side.

6. The multi-functional display according to claim 1, wherein a connecting portion is further arranged between the longitudinal rod and the display screen, the connecting portion includes a first connecting unit and a second connecting unit pivotally connected with the first connecting unit, and the first connecting unit is rotationally connected with the display screen; and the second connecting unit is connected with the longitudinal rod in an inserted mode, so that the display screen is arranged to be connected with or separated from the base, and when the display screen is separated from the base, the second connecting unit and a bottom of the display screen are arranged to form a supporting state for the display screen.

7. The multi-functional display according to claim 6, comprising a liquid crystal display (LCD) control board, the LCD control board is accommodated in the second connecting unit, and the LCD control board is arranged to be electrically connected to the display screen via a flexible connecting line.

8. The multi-functional display according to claim 7, wherein the multi-functional display further comprises a screen control board, the screen control board is arranged on the display screen, or the screen control board is arranged on the second connecting unit.

9. The multi-functional display according to claim 6, wherein the connecting portion includes a connecting body arranged on a back face of the display screen and a connecting cover body arranged on a back face of the connecting body, and the connecting cover body is provided with a connecting back face that faces away from the display screen; the supporting portion is provided with a supporting back face that faces away from the display screen; and the multi-functional display further comprises a pivoting mechanism, the pivoting mechanism includes a first pivoting portion arranged on the connecting portion and a second pivoting portion arranged on the supporting portion, a rotating mechanism is arranged between the second pivoting portion and the first pivoting portion, the rotating mechanism includes an arc-shaped rotating groove and a rotating shaft limited in the rotating groove, and a rotating center of the rotating groove is located on an intersection line of the connecting back face of the connecting cover body and the supporting back face.

10. The multi-functional display according to claim 9, wherein the rotating shaft includes a bolt, a cam, a spring gasket and a nut, and the bolt sequentially penetrates through the second pivoting extension unit and the first pivoting extension unit; the nut is arranged on the bolt, the cam is arranged between the nut and the first pivoting extension unit, one end of the cam is arranged to abut against the first pivoting extension unit, the spring gasket is arranged between the cam and the nut, and the spring gasket is arranged to abut against the cam and the nut respectively; and the first pivoting extension unit is provided with a groove on one side of the first pivoting extension unit facing the cam, the cam is provided with a protrusion in a direction facing the first pivoting extension unit, and when the second pivoting extension unit and the first pivoting extension unit are in a horizontal state, the protrusion of the cam is accommodated in the groove of the first pivoting extension unit, and the spring gasket is in a force release state.

11. The multi-functional display according to claim 9, wherein the connecting cover body and the supporting portion are tightly attached to an intersection line, and the connecting cover body rotates around the intersection line relative to the supporting portion.

12. The multi-functional display according to claim 9, wherein the rotating shaft is located on one side of the connecting portion close to the supporting portion.

13. A display screen system, comprising a first display and a second display, wherein the first display includes a support, the support includes a longitudinal rod;
a rectangular display screen, wherein the display screen is provided with a first length side and a second length side opposite to each other, and a first width side and a second width side opposite to each other; and the display screen is arranged to rotate relative to the longitudinal rod around an axis, and a distance between the axis and the first length side is not equal to a distance between the axis and the second length side; and
wherein, the first display is provided with at least a first working state and a second working state; in the first working state, the first length side and the second length side are both parallel to a horizontal axis, and the first length side is located below the second length side; in the first working state, a height capable of accommodating the second display is arranged between the first length side and the support; and the second display is located below the first display.

14. The display screen system according to claim 13, wherein in the first working state, the first display and the second display are positioned via a magnetic attraction structure.

15. A display screen system, comprising a plurality of multi-functional displays arranged in parallel, wherein each of the plurality of multi-functional displays is in a third working state and/or a fourth working state; and
in the third working state, the first width side and the second width side are both parallel to the horizontal axis, and the first width side is located below the second width side; and in the fourth working state, the second width side and the first width side are both parallel to the horizontal axis, and the second width side is located below the first width side.
